(19) United States
(12) Patent Application Publication
(10) Pub. No.: US 2004/0083490 A1
(43) Pub. Date: Apr. 29, 2004

(54) Program recommendation system, program recommendation method and program for realizing the same

(75) Inventor: Hidetaka Hane, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/985,150

(22) Filed: Nov. 1, 2001

(30) Foreign Application Priority Data
Nov. 2, 2000 (JP) 340405/2000

(51) Int. Cl. H04N 5/445; G06F 13/00; G06F 3/00; H04N 7/10; H04N 7/025

(52) U.S. Cl. 725/46; 725/34; 725/35

(57) ABSTRACT

Keywords featuring a program which a user may like are extracted from EPG data representing a program to be broadcasted. A predetermined additional value is added to each of the extracted keywords, so as to create a plurality of profiles, The plurality of profiles emphasize different kinds of keywords, and the additional value to be added to each of the keywords differs in accordance with a degree of the emphasis. Hence, the plurality of profiles can represent the user preference from different aspects. The program to be recommended is determined using one of the created profiles.

### BACKGROUND OF THE INVENTION

1. Field of the Invention

The present invention relates to a program (TV program, etc.) recommendation system, a program recommendation method and a program for realizing the same.

2. Description of the Related Art

The technique disclosed in Unexamined Japanese Patent Application KOKAI Publication No. H7-135621 determines the user preference of programs, based on the time period during which a user continuously watches a certain program, and recommends a program to the user.

Specifically, the user preference is expressed by keywords included in the title or the like of a target program to be watched or recorded by the user and also by the appearance frequency of each of the keywords. The values indicating the appearance frequency are increased in accordance with the time period during which the user continuously watched a program. For example, if the user watches a program continuously for ten minutes, a value “10” is added to the values indicating the appearance frequency, and if the user continuously watches the program for another ten minutes, a value “10” is further added thereto. Hence, the longer the user watches, the larger the value of the appearance frequency.

The program to be recommended to the user is determined based on the appearance frequency of each keyword, which is obtained in the above manner. Specifically, the values of the appearance frequency of the keywords are summed in the unit of each of the candidate programs to be recommended, and the programs are recommended in the descending order of the summed values.

There are a variety of points based on which a user selects programs. For example, the user may select a program to watch, in accordance with whether the program has a title implying a serial play or whether a particular cast (the actor, singer, etc.) appears in the program.

The technique disclosed in Unexamined Japanese Patent Application KOKAI Publication No. H7-135621 adds the values in accordance with the time period during which the user continuously watches the program to the appearance frequency, and determines the order in which the programs are recommended one after another using the calculated appearance frequency. In other words, according to this technique, a single profile is created without identifying various user preferences. In addition, according to this technique, the programs to be recommended are determined based on the created single profile. Thus, the user preference can not adequately be determined, so that the user can not be provided with programs which meet the his/her preference.

Specifically, in the case where the user watches a program having a particular title continuously for a long period of time, the appearance frequency of each keyword other than the title, based on which the user selects the program to watch, becomes high along with the appearance frequency of the title. In the case where the user watches a program showing a particular cast continuously for a long period to time, the appearance frequency of any keywords other than the cast, based on which the user selects the program to watch, becomes high along with the appearance frequency of the cast Thus, the keyword representing the user preference can not clearly be distinguished from any other keywords. As a result of this, the user preference can not appropriately be determined, so that programs which meet the user preference can not be recommended to the user.

The entire contents of Unexamined Japanese Patent Application KOKAI Publication No. H7-135621 are herein incorporated by reference.

### SUMMARY OF THE INVENTION

The present invention has been made in consideration of the above. It is accordingly an object of the present invention to provide a system, method and program for recommending a program which meets the user preference.

In order to attain the above object, according to the first aspect of the present invention, there is provided a program recommendation system comprising:

a profile creator which creates a plurality of profiles showing characteristics of programs which a user may like from different aspects; and

a to-be-recommended program determiner which determines at least one program to be recommended to the user, using one of the plurality of profiles.

According to this invention, any programs which meet the user preference can be recommended.

The program recommendation system may further comprise

a recommended-program display unit which displays at least one recommended program determined by the to-be-recommended program determiner.

In the program recommendation system:

the profile creator may include

an extraction unit which extracts a plurality of keywords featuring programs which the user may like, from EPG (Electronic Program Guide) data representing information of programs to be broadcasted, and

an adder which adds a predetermined additional value to a profile value representing frequency of extracting each of the plurality of keywords, for each of the plurality of keywords, thereby creating the plurality of profiles;

the plurality of profiles may emphasize a plurality of kinds of keywords, respectively; and

the adder may change the additional value for each of the plurality of kinds of keywords, in accordance with a degree of the emphasis.

The program recommendation system way further include a record reservation unit which sets a program reserved to be recorded, in accordance with user operations; and

the extraction unit may extract at least one keyword of the program set by the record reservation unit as the keyword featuring the programs that the user may like.

The program recommendation may system further include a program-table display unit which displays a table of programs, based on the EPG data; and

the record reservation unit may set a program that the user selects on the table of programs as the program reserved to be recorded.

The program recommendation system may further include a selector making the user select one of the plurality of kinds of keywords; and

the to-be-recommended program determiner may determine the at least one program to be recommended, based on the profile which has been created based on the selected kind of keyword.

The kinds of keywords may include a title, cast, type and contents of a program.

The recommended-program display unit may display a reason for which the at least one program is determined to be recommended.

In order to achieve the above object, according to the second aspect of the present invention, there is provided a program recommendation method, comprising:

creating a plurality of profiles showing characteristics of programs which a user may like from different aspects; and

determining at least one program to be recommended to the user, using one of the plurality of profiles.

The program recommendation method may further comprising

displaying the at least one program.

The creating may include

extracting a plurality of keywords featuring program which the user may like from EPG (Electronic Program Guide) data representing information of programs to be broadcasted, and

adding a predetermined additional value to a profile value representing frequency of extracting each of the plurality of keywords, for each of the plurality of keywords, thereby creating the plurality of profiles;

the plurality of profiles may emphasize a plurality of kinds of keywords, respectively; and

the adding may include changing the additional value for each of the plurality of kinds of keywords, in accordance with the a degree of the emphasis.

The program recommendation method may further include setting a program reserved to be recorded, in accordance with user operations; and

the extracting may include extracting at least one keyword of the program reserved to be recorded, as the keyword featuring the programs that the user may like.

The program recommendation method may further include displaying a table of programs, based on the EPG data; and

the setting the program reserved to be recorded may include setting a program that the user selects on the table of programs as the program reserved to be recorded.

The program recommendation method may further include making the user select one of the plurality of kinds of keywords; and

the determining may include determining the at least one program to be recommended, based on the profile which has been created based on the selected kind of keyword.

The kinds of keywords may include a title, cast, type and contents of a program.

The displaying the at least one program may include displaying a reason for which each of a plurality of programs is determined to be recommended.

In order to achieve the above object, according to the third aspect of the present invention, there is provided a program for controlling a computer to function as a program recommendation system, comprising:

a profile creator which creates a plurality or profiles showing different aspects of characteristics of programs which users may like; and

a to-be-recommended program determiner which determines at least one program to be recommended to each of the users, using one of the plurality of profiles.

### BRIEF DESCRIPTION OF THE DRAWINGS

The object and other objects and advantages of the present invention will become more apparent upon reading of the following detailed description and the accompanying drawings in which:

FIG. 1 is a block diagram showing the structure of a program recommendation system according to an embodiment of the present invention;

FIG. 2 is a diagram showing functions of a system controller included in the program recommendation system of FIG. 1;

FIG. 3 is a diagram showing a table of programs;

FIG. 4 is a flowchart showing a process for creating an EPG (Electronic Program Guide) vector, which is carried out by the system controller of FIG. 2;

FIG. 5 is a diagram showing the structure of EPG data included in broadcast waves;

FIG. 6 is a diagram showing the structure of an EPG vector which is created based on the EPG data;

FIG. 7 is a diagram showing a plurality of user profiles emphasizing different points from each other;

FIG. 8 is a flowchart showing a process of learning user preference, which is carried out by the system controller;

FIGS. 9A and 9B are diagrams each showing the structure of a user profile;

FIG. 10 is a flowchart showing a process of determining a program to be recommended, which is carried out by the system controller;

FIG. 11 is a diagram showing the structure of a recommendation page showing recommended programs;

FIG. 12 is a diagram showing another structure of a recommendation page showing recommended programs; and

FIG. 13 is a diagram showing still another structure of a recommendation page showing recommended programs.

### DETAILED DESCRIPTION OF THE PREFERRED EMBODIMENT

A program recommendation system according to an embodiment of the present invention will now be described with reference to the accompanying drawings.

The program recommendation system according to the embodiment of the present invention creates a plurality of user profiles showing characteristics of programs that a user might like to watch, and recommends programs to the user based on the created user profiles.

One of the characteristics of the present invention is that the program recommendation system creates a plurality of user profiles emphasizing different points from each other. For example, the program recommendation system creates one user profile emphasizing a program title and another user profile emphasizing the cast of a program. The emphasized point is set in advance by the user. A method of creating the user profiles will more specifically be described later.

Another characteristic of the present invention is that the program recommendation system makes the user select the point based on which the program recommendation system selects programs to be recommended. The program recommendation system selects programs to be recommended, using a user profile which has been created while emphasizing the user-selected point. A method of selecting programs to be recommended will more specifically be described later.

Still another characteristic or the present invention is that the program recommendation system provides the user with a keyword which is the most useful keyword for selecting each recommended program, together with each of the recommended programs. A method of providing the recommended programs will more specifically be described later.

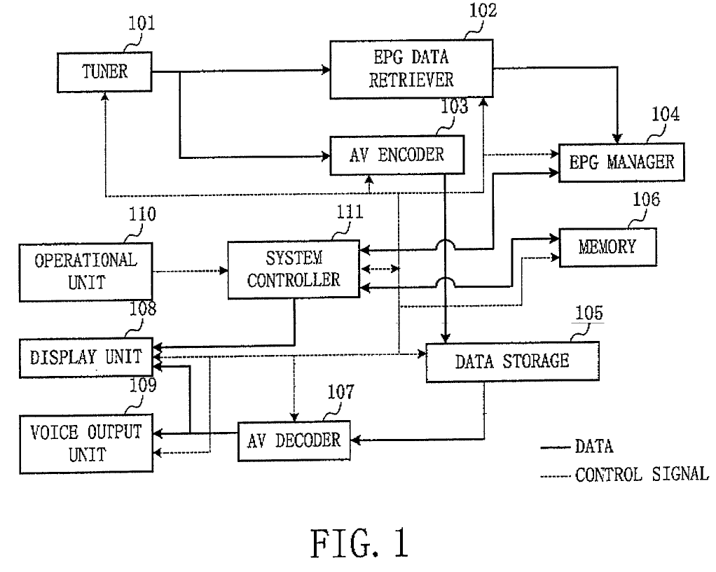

The program recommendation system comprises, as illustrated in FIG. 1, a tuner 101, an EPG data retriever 102, an AV encoder 103, an EPG data manager 104, a data storage 105, a memory 106, an AV decoder 107, a display unit 108, a voice output unit 109, an operational unit 110 and a system controller 111.

The tuner 101 includes an antenna, etc., and receives broadcast waves of TV programs. The tuner 101 selects broadcast waves of a predetermined channel under the control of the system controller 111. The tuner 101 supplies the EPG data retriever 102 and the AV encoder 103 with the selected broadcast waves.

The EPG data retriever 102 extracts EPG (Electronic Program Guide) data included in the supplied broadcast waves, under the control of the system controller 111. The EPG data retriever 102 outputs the extracted EPG data to the EPG manager 104. The EPG data represents program titles, schedules times, cast, types and brief explanations of programs broadcasted on each channel. The EPG data is included in the broadcast waves, for example, at VBI (Vertical Blanking Interval).

The AV encoder 103 converts analog audio/visual data included in the supplied broadcast waves into digital AV (Audio Visual) data, under the control of the system controller 111. The AV encoder 103 outputs the converted AV data to the data storage 105 In this case, this AV data may be in the format of, for example, MPEG-2 (Moving Picture Expert Group-2) or the like.

The EPG manager 104 may be a RAM (Random Access Memory) that the system controller 111 can directly access or a secondary memory unit, such as a hard disk, etc. The EPG manager 104 stores and manages the supplied EPG data under the control of the system controller 111. The EPG manager 104 stores and manages also an EPG vector of each program which is created based on the EPG data. Each EPG vector is composed of several components (the program title, the cast, the type of the program, etc.) which feature each program and are extracted from the EPG data, and is used for creating the user profiles, as will more specifically be explained later.

The data storage 105 includes a hard disk, etc. The data storage 105 stores the AV data supplied from the AV encoder 103, under the control of the system controller 111, so as to record a program.

The memory 106 includes a RAM (Random Access Memory) and a ROM (Read Only Memory), etc. The memory 106 stores a word dictionary which is provided in advance and used for generating EPG vectors from the EPG data. The memory 106 stores also reservation information representing a program reserved by the user to record and user profiles, etc. under the control of the system controller 111.

The AV decoder 107 reads the AV data stored in the data storage 105 while a recorded program is replayed, under the control of the system controller 111. The AV decoder 107 decodes the read AV data, thereby generating analog audio/visual signals. The AV decoder 107 outputs the generated audio/visual signals to the display unit 108 and the voice output unit 109.

The display unit 108 includes a CRT (Cathode Ray Tube) or a liquid crystal panel or the like. The display unit 108 displays pictures of a program using the audio/visual signals supplied from the AV decoder, under the control of the system controller 111. The display unit 108 displays a table of programs, etc. under the control of the system controller 111.

The voice output unit 109 includes an amplifier, a speaker, and the like. The voice output unit 109 outputs voices of a program using the audio/visual signals supplied from the AV decoder 107, under the control of the system controller 111.

The operational unit 110 consists of an infrared ray remote controller having a plurality of operational buttons and an infrared ray receiver, or includes a panel switch, etc. which is arranged on the casing of the program recommendation system. The operational unit 110 is operated by the user and outputs signals corresponding to the user operations to the system controller 111.

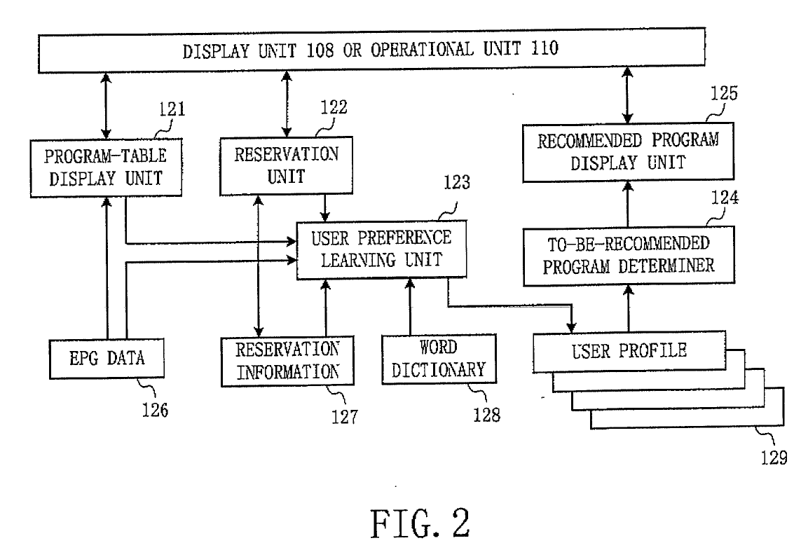

The system controller 111 is composed of a RAM, a ROM and a CPU (Central Processing Unit), and stores various programs which are prepared in advance. The system controller 111 executes the stored program in response to a signal supplied from the operational unit 110. The system controller 111 controls each of the above-described units in accordance with the executed program. In this structure, the system controller 111 functions as a program-table display unit 121, a reservation unit 122, a user preference learning unit 123, a to-be-recommended program determiner 124 and a recommended program display unit 125, which are illustrated in FIG. 2.

The system controller 111 serving as the program-table display unit 121 creates a table of programs, based on EPG data 126 stored in the EPG manager 104.

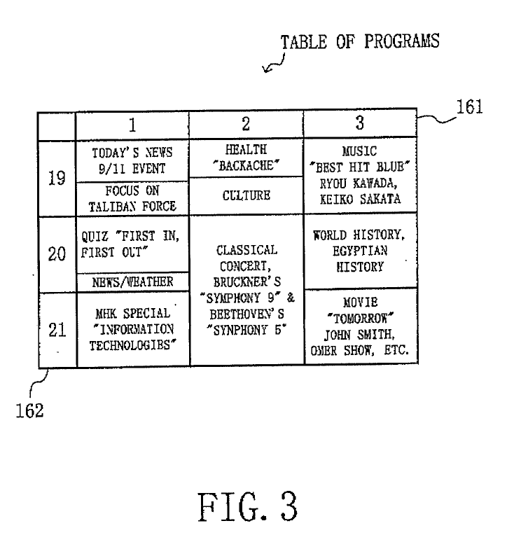

As shown in FIG. 3, the table of programs shows a set of channels 161, a set of scheduled-times 162 and programs to be on the air on each channel.

The system controller 111 serving as the program-table display unit 121 controls the display unit 108 to display the created table of programs.

The user operates the operational unit 110 to change the values of the channels 161 and scheduled-times 162, thereby to search for programs on various channels and times. The user operates the operational unit 110 to mark a favorite program on the table of programs or select a target program that the user reserves for recording.

The system controller 111 serving as the reservation unit 122 sets a program(s) to be recorded in accordance with the operations of the user. Specifically, the system controller 111 serving as the reservation unit 122 stores information representing the user-selected program(s) as reservation information 127, in the memory 106.

The system controller 111 serving as the user preference learning unit 123 creates EPG vectors, using the EPG data 126 stored in the EPG manager 104 and the word dictionary 128 stored in the memory 106, as will more specifically be explained later. The system controller 111 stores the created EPG vectors in the memory 106. It can be assumed that the user likes the reserved program. The system controller 111 serving as the user preference learning unit 123 creates a plurality of user profiles 129 using the EPG vector(s) of the reserved program(s), and stores the created user profiles 129 in the memory 106.

The system controller 111 serving as the to-be-recommended program determiner 124 determines programs to be recommended from a plurality of programs, using one of the user profiles 129 which is selected based on the user operations, as will more specifically be explained later.

The system controller 111 serving as the recommended-program display unit 125 controls the display unit 108 to display a recommendation page showing the determined programs to be recommended. The user operates the operational unit 110 to select a program to watch or reserve a target program to be recorded on the displayed recommendation page.

Explanations will now be made to operations of the program recommendation system, for leaning the user preference, for determining programs to be recommended, and for displaying recommended programs.

(1) Learning User Preference

The system controller 111 creates an EPG vector of each program based on the EPG data 126, before learning the user preference. At this time, the system controller 111 functions as the user preference learning unit 123, in accordance with a preset program.

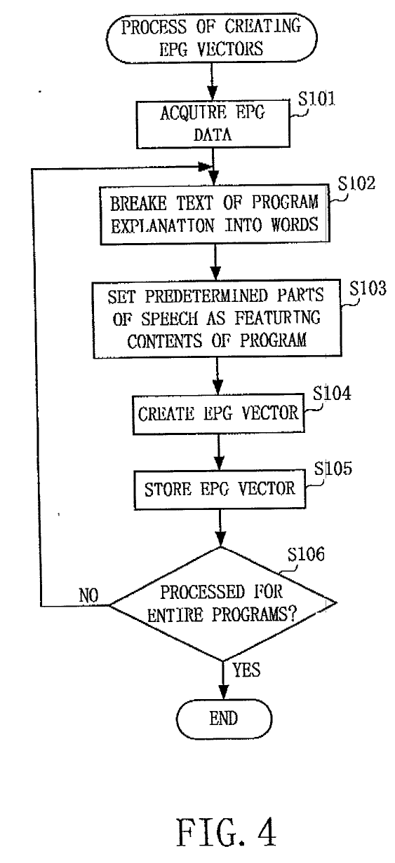

FIG. 4 is a flowchart showing a process of creating EPG vectors, which is carried out by the system controller 111.

The system controller 111 acquires the EPG data 126 from the EPG manager 104 (Step S101).

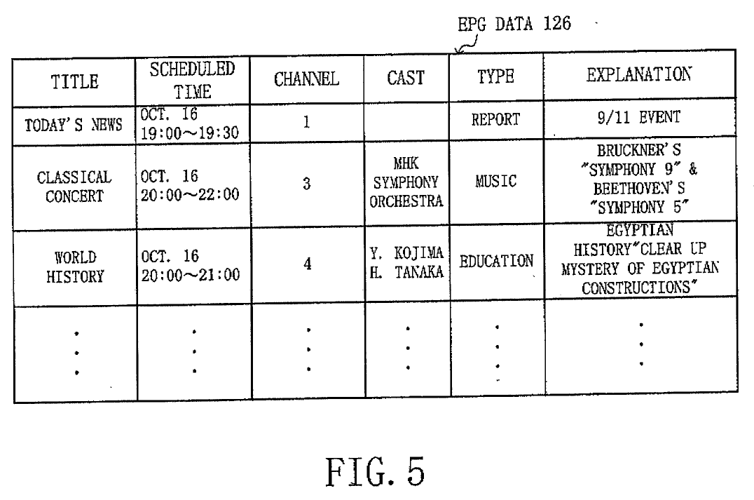

As shown in FIG. 5, the EPG data 126 is composed of data items representing a program title, scheduled time, channel, cast, type, brief explanation of each of the programs.

The system controller 111 selects one of the programs shown in the EPG data 126. The system controller 111 breaks the text of the brief explanation of the selected program into words (Step S102). Particularly, the system controller 111 performs morpheme analysis using the word dictionary 128 in the memory 106, thereby breaking the text of the brief explanation into words.

The morpheme analysis is employed in a text analysis process, and is to dissolve the text into information representing parts of speech and into words, in accordance with the grammatical rules of the corresponding language. The word dictionary 128 includes information representing the grammatical rules, the words, and parts of speech of the words for breaking the text into words.

Of retrieved words, the system controller 111 sets some words of predetermined parts of speech (common nouns, proper nouns, etc.) as characteristic words which feature the contents of the corresponding program (Step S103).

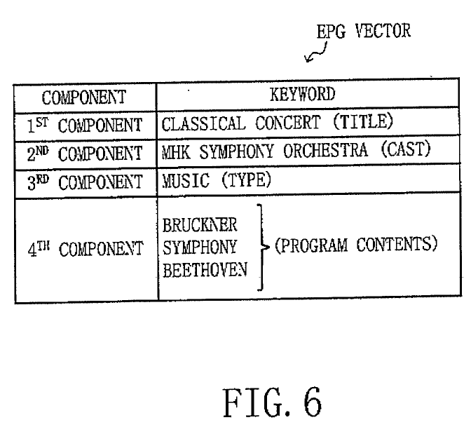

As shown in FIG. 6, the EPG vector is composed of four components featuring the corresponding program. The first component is the program title, the second component is the cast of the program, the third component is the type of the program, and the fourth component is the contents of the program. The characteristic words set in the step S103 are keywords showing the contents of the program included in the EPG vector as the fourth component.

After this, the system controller 111 creates an EPG vector of the program selected in the step S102 (Step S104). Particularly, the system controller 111 extracts keywords representing the title, cast, and type of the selected program from the EPG data 126. The system controller 111 creates the EPG vector including the extracted keyword or the program title as the first component, the keyword of the cast as the second component, the keyword of the type of the program as the third component, and the keywords (the characteristic words) set in the step S103 as the fourth component.

The example of the EPG vector shown in FIG. 6 is an EPG vector of the program shown in the second level of the program table (the EPG data 126) of FIG. 5. Extracted from the EPG data 126 are the keyword “classical concert” indicating the title as the first component of the EPG vector, the keyword “MHK symphony orchestra” indicating the cast of the program as the second component, and the keyword “music” indicating the type of the program as the third component. The keywords for the contents of the program as the fourth component include “Bruckner”, “symthony”, and “Beethoven”.

The system controller 111 stores the EPG vector created in the step S104 in the EPG manager 104 (Step S105).

The system controller 111 determines whether the above procedures are completed for the entire programs shown in the EPG data 126 (Step S106).

In the case where the above procedures are not performed for the entire programs (Step S106; NO), the system controller 111 returns to the procedure of the step S102. Then, the system controller 111 carries out the above procedures for any of those program for which the procedures are not done.

On the contrary, in the case where the above procedures are performed for the entire programs (Step S106; YES), the system controller 111 completes the process of creating the EPG vectors.

Accordingly, the EPG vector of each of the programs shown in the EPG data 126 is created.

After the completion of the process of creating the EPG vectors, the system controller 111 serving as the user preference learning unit 123 carries out a process of learning user preference, as will be described later. By this process of learning the user preference, a plurality of user profiles 129 showing the characteristics of user's favorite programs are created.

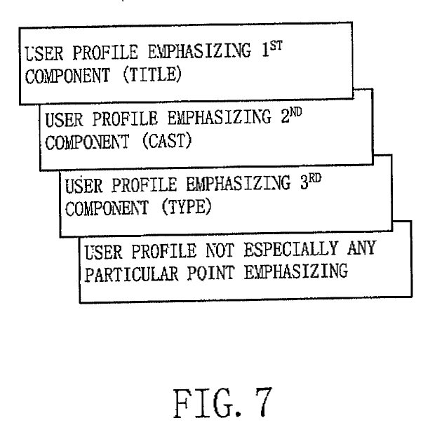

As described above, the plurality of user profiles 129 emphasize different points from each other. The emphasize point is the component included in the EPG vector. As illustrated in FIG. 7, the plurality of user profiles 129 are created to emphasize different components from each other. The emphasized point in each of the plurality of user profiles 129 is set in advance by the user.

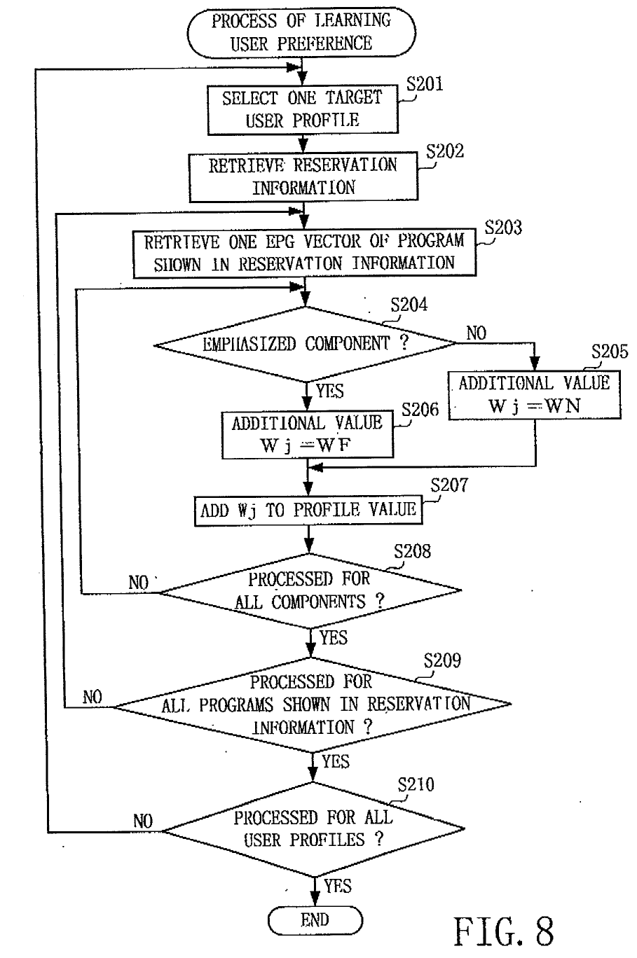

FIG. 8 is a flowchart showing the process of leaning the user preference, which is carried out by the system controller 111.

The system controller 111 selects one target profile, from the plurality of user profiles 129 to be created (Step S201).

The system controller 111 retrieves the reservation information 127 from the memory 106 (Step S202).

Subsequently, the system controller 111 retrieves one of the EPG vector(s) of the program(s) shown in the reservation information 127, from the EPG manager 104 (Step S203).

The system controller 111 creates the user profile 129 using the retrieved EPG vector as the follow: As described above, it can be assumed that the program which is reserved to be recorded is one of the user favorite programs. Thus, the user profile 129 to be created can show the characteristics of the user favorite programs.

The system controller 111 selects one component of the retrieved EPG vector. For example, the system controller 111 selects the first component (title of the program). The system controller 111 determines what component is emphasized in the user profile 129 selected in the step S201. Subsequently, the system controller 111 determines whether the selected component is the emphasized component (Step S204).

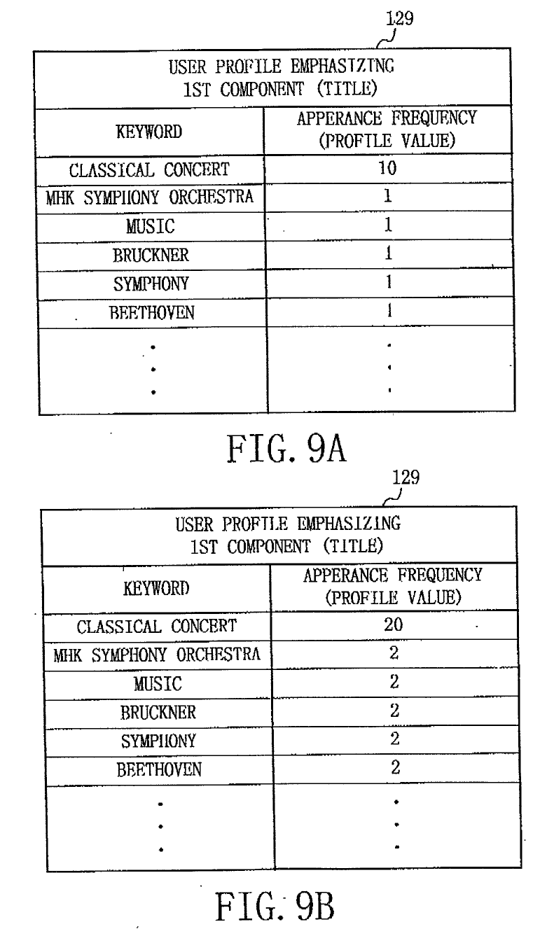

As shown in FIG. 9A, the user profile 129 shows the keyword of each component included in the EPG vector and its appearance frequency (profile value). As will be explained later; the system controller 111 adds a predetermined value to the profile value of the same keyword as the keyword of the selected component, to create the user profile 129. Note that different values are added to the profile values of the respective emphasized component and un-emphasized component. Hence, the system controller 111 determines those different additional values in the procedure of the step S204.

In the case where it is determined that the selected component is not the emphasized component (Step S204; NO), the system controller 111 sets a predetermined value WN as an additional value Wj (Step S205), and executes the procedure of the step S207, as will be explained later.

On the contrary, in the case where it is determined that the selected component is the emphasized component (Step S204; YES), the system controller 111 sets a predetermined value WF as an additional value Wj (WF>WN) (Step S206).

The system controller 111 adds the set additional value Wj to the profile value of the user profile 129 (Step S207).

Specifically, the system controller 111 determines whether the same keyword as the keyword of the selected component has already been registered in the user profile 129. In the case where it is determined that the same keyword has not already been registered, the system controller 111 registers the keyword of the selected component in the user profile 129, and adds the set additional value Wj to the profile value. On the contrary, in the case where it is determined that the same keyword has already been registered the system controller 111 adds the set additional value Wj to the profile value of the same keyword as that of the selected component.

Thereafter, the system controller 111 determines whether the above procedures have been performed for the entire components of the EPG vector(s) retrieved in the step S203 (Step S208).

In the case where it is determined that the above procedures for the entire components have not yet been performed (Step S208; NO), the system controller 111 returns to the procedure of the step S204. Then the system controller 111 carries out the above procedures for the next component.

On the contrary, in the case where it is determined that the above procedures for the entire components have been performed (Step S208; YES), the system controller 111 now determines whether the above procedures have been achieved for the entire programs shown in the reservation information 127 (Step S209).

In the case where it is determined that the above procedures have not yet been performed for the entire programs (Step S209; NO), the system controller 111 returns to the procedure of the step S203. Then, the system controller 111 carries out the above procedures for any of those programs for which the above procedures haven't been done.

On the contrary, in the case where it is determined that the above procedures have been performed for the entire programs (Step S209; YES), the system controller 111 determines whether the above procedures have been completed for all of the target user profiles 129 to be created (Step S210).

In the case where it is determined that the above procedures have not yet been completed for all of the target user profiles 129 (Step S210; NO), the system controller 111 returns to the procedure of the step S201. The system controller 111 carries out the above procedures for any of the target user profiles 129 for which the above procedures have not been done.

On the contrary, in the case where it is determined that the above procedures have been completed for all of the target user profiles 129 (Step S210; YES), the system controller 111 completes the process of learning the user preference.

Accordingly, different additional values Wj are added to any of the emphasized components and to any of the un-emphasized components, so that the user profiles 129 clearly showing the preference of the user can be created. The plurality of user profiles 129 emphasize different points from one to another, so that the user profiles 129 showing a variety of user preference from different aspects.

For example, in the case where the additional value Wj of the emphasized component is set to “10” and the additional value Wj of the un-emphasized component is set to “1”, the user profile 129 shown in FIG. 9A will be updated as shown in FIG. 9B by processing the EPG vector of FIG. 6.

The user profile 129 of FIG. 9A emphasizes the first component (the title). Hence, the profile value of the title increments at the highest rate among any other profile values of the rest of components. Because the profile value of the title increments at a high rate, there is a large difference between the profile value of the title of a program that the user may like and the profile value of any other titles of programs that the user may not like. Thus, the user profile 129 clearly indicates the title of the program that the user may like. Because the plurality of user profiles 129 emphasize different points from each other, the user profiles 129 can clearly show the user preference over different components.

The system controller 111 serving as the preference learning unit 123 stores the plurality of user profiles 129 created in the process of learning the user preference in the memory 106. Each of the user profiles 129 is used when determining programs to be recommended, as will now be described.

(2) Determining Program to be Recommended

The system controller 111 functions as the to-be-recommended program determiner 124 in accordance with a pre-set program, when determining programs to be recommended.

The user operates the operational unit 110 to specify the emphasized point, for determining programs to be recommended. The user can specify the point on a recommendation page showing recommended programs or on a predetermined menu page, etc.

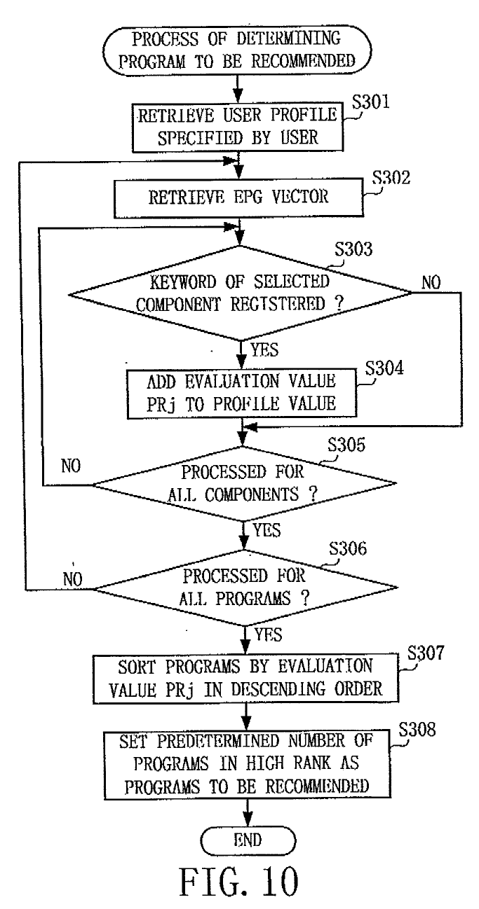

Upon specification of the point, the system controller 111 carries out a process of determining programs to be recommended, as shown in FIG. 10. In this process, the system controller 111 determines target programs to be recommended to the user, of a plurality of programs shown in the EPG data 126 of the EPG manager 104.

The system controller 111 retrieves the user profile 129 emphasizing the point specified by the user from the memory 106 (Step S301).

The system controller 111 selects one program, of the programs shown in the EPG data 126. The system controller 111 retrieves an EPG vector of the selected program from the EPG manager 104 (Step S302).

The system controller 111 selects one component of the retrieved EPG vector. For example, the system controller 111 selects the first component (title of the program). Then, the system controller 111 determines whether any of the keywords of the selected component is registered in the user profile 129 retrieved in the step S301 (Step S303).

In the case where it is determined that the keyword of the selected component is not registered (Step S303; NO), the system controller 111 carries out the procedure of step S305, as will be explained later.

On the contrary, in the case where it is determined that the keyword of the selected component is registered (Step S303; YES), the system controller 111 retrieves the profile value of the keyword from the user profile 129. Then, the system controller 111 adds the retrieved profile value to an evaluation value Pri of the program selected in the step S302 (Step S304).

The profile value indicates the degree of the user preference. Hence, the larger the evaluation value PRj becomes, the more the selected program is likely to meet the user preference.

After this, the system controller 111 determines whether the above procedures have been performed for the entire components of the EPG vector retrieved in the step S302 (Step S305).

In the case where it is determined that the above procedures have not been performed for the entire components (Step S305; NO), the system controller 111 returns to the procedure of the step S303. Then, the system controller 111 performs the above procedures for the next component.

On the contrary, in the case where it is determined that the above procedures have been performed for the entire components (Step S305; YES), the system controller 111 determines whether the above procedures have been performed for the entire programs shown in the EPG data 126 (Step S306).

In the case where it is determined that the above procedures have not been performed for the entire programs (Step S306; NO), the system controller 111 returns to the procedure of the step S302. Then, the system controller 111 performs the above procedures for any of those programs for which the procedures have not been done.

On the contrary, in the case where it is determined that the above procedures have been performed for the entire programs (Step S306; YES), the system controller 111 sorts the programs by the evaluation values PRj in the descending order (Step S307).

The system controller 111 sets a predetermined number of programs which are sorted in high ranks by the evaluation values PRj as programs to be recommended to the user (Step S308), and completes the process of determining the programs to be recommended. The number of programs which can be set as recommended programs at a time is set in accordance with the nunber of programs which can be displayed at once on the recommendation page, for example.

Accordingly, the recommended programs to be provided to the user are determined.

(3) Displaying Recommended Programs

The system controller 111 functions as the recommended-program display unit 125 in accordance with a prepared program, when providing the recommended programs.

The system controller 111 controls the display unit 108 to display the recommendation page showing the recommended program determined in the above process of determining the programs to be recommended.

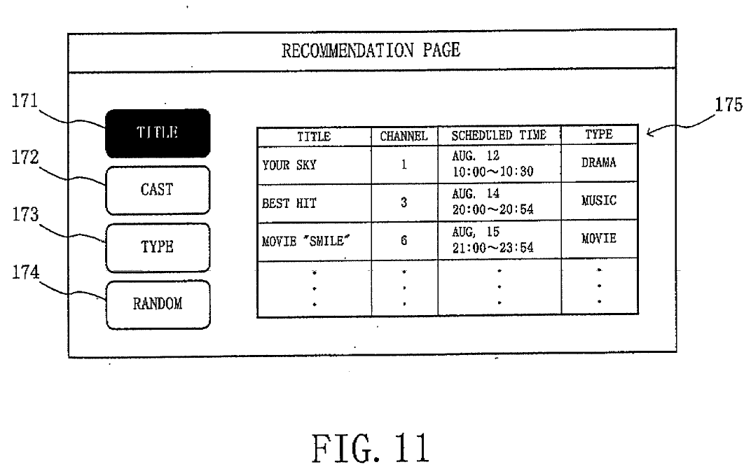

The recommendation page shown in FIGS. 11, 12 or 13 is displayed on the display unit 108, for example.

The recommendation page of FIG. 11 shows items 171, 172, 173 and 174 For showing the user profiles 129 and also a table of recommended programs 175.

The table 175 is composed of several kinds of columns of “Title”, “Channel”, “Scheduled Time” and “Type of Program”. The item 171 which is turned over or has different color from the rest of the items indicates the user profile 129 which is used for determining the recommended programs.

The user operates the operational unit 110 to select one of the items 171, 172, 173 and 174, so as to change the user profile 129 for use in determining the programs to be recommended.

In response to the change to be made in the user profile 129, the system controller 111 carries out the above-described process of determining the programs to be recommended. Then, the system controller 111 newly sets recommended programs, and provides the user with the set programs. In this manner, the user specifies the point for selecting the programs to be recommended, thereby determining the programs to be recommended so as to highly meet with the user preference.

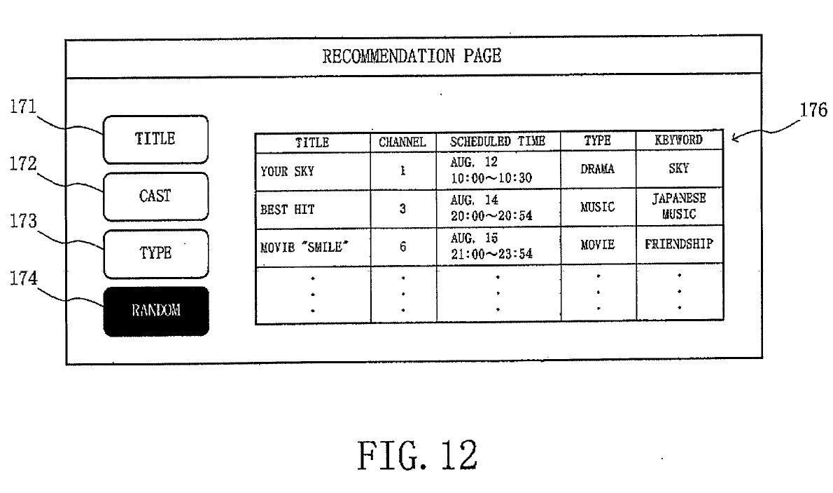

The recommendation page of FIG. 12 is a table showing the recommended programs which are determined using the user profile 129 which does not especially emphasize any particular point. The recommendation page of FIG. 12 shows the items 171, 172, 173 and 174 and a table of recommended programs 176.

The table 176 includes “Keyword” columns showing a keyword of each program which is the most useful keyword for determining a program to be recommended, in addition to the sets of columns included in the table 175 of FIG. 11. The keyword shown in each “Keyword” column is one having the largest profile value among the keywords of the same program. In such circumstances, the user can understand the reasons why each program is recommended.

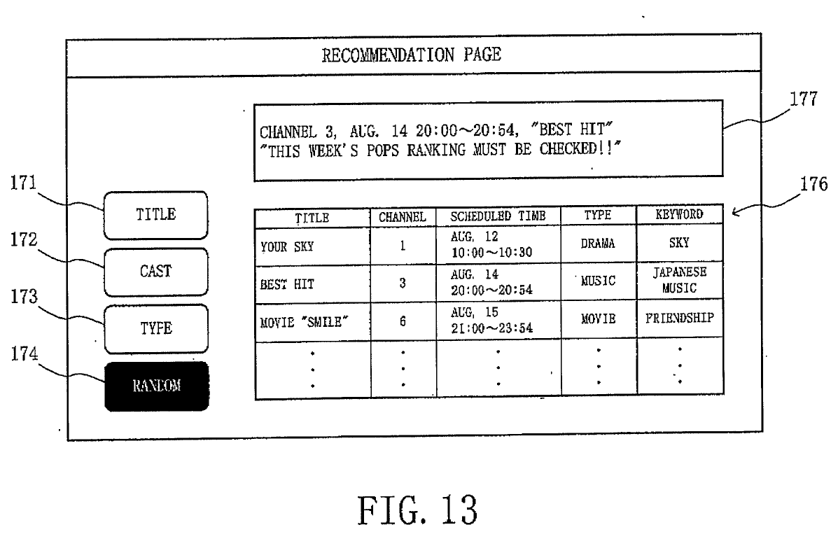

The recommendation page of FIG. 13 shows the items 171, 172, 173 and 174, the table of the recommended programs 176 and a space 177 for showing the brief explanations of a corresponding program.

The user operates the operational unit 110 to move the cursor, and can select one recommended program shown in the table 176. The system controller 111 retrieves the brief explanation of the recommended program which the user selected, from the EPG data 126. Then, the system controller 111 controls the display unit 108 to display the brief explanation of the selected program in the space 177. Hence the user can get the contents of the recommended programs with ease, and can determine whether the recommended programs are those he/she can really wish to watch based on the brief explanation.

In the above embodiment the explanations have been made to the exemplary case where the additional value Wj of each component is set to two values of “10” and “1” in accordance with the degree of the emphasized point. However, the additional value Wj may be changed in accordance with the rank of the user-emphasized points. The additional value Wj may be changed in stages, for example, in the order of “8”, “4”, “2” and “1”.

Kinds of the keywords may not be the above-described “Title”, “Cast”, “Type” and “Explanation”. For example, the kinds of the keywords may include “Person”, “Sports” or “Animal”, etc.

The point to emphasize is not limited to the component of the EPG vector. For example, a plurality of user profiles 129 may be created while emphasizing different keywords, respectively. Upon creation of the user profiles 129, one or more programs including the user-emphasized keyword can be determined as recommended programs.

Any method of determining the program to be recommended may be employed other than the above method wherein the appearance frequency of keyword is calculated. For example, the Bayesian inference or the like which is widely employed, for example in pattern recognition, text matching, etc. may be used.

The program recommendation system may record the audio/visual data of a corresponding program in the form of analogue data on a video tape, etc.

The television broadcasting may be digital broadcasting instead of the analogue broadcasting.

The system of the present invention can be realized by a general computer, without the need for a dedicated system. A program and data for controlling a computer to execute the above-described processes may be recorded on a magnetic recording medium (e.g. a floppy disk, etc.), an optical recording medium (e.g. CD-ROM, DVD, etc.) or a semiconductor recording medium (e.g. memory card, etc.) and distributed, and the program may be installed into the computer and run on an OS (Operating System) to execute the above-described processes, thereby achieving the system of the present invention. The above program and data may be stored in a disk device or the like included in the server device on the Internet, or embedded in a carrier wave, and the program and data embedded in the carrier wave may be downloaded into the computer so as to realize the system of the present invention.

Various embodiments and changes may be made thereonto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-340405 filed on Nov. 2, 2000, and including specification, claims, drawings and summary. The disclosure of the above Japanese Patent Application is incorporated herein by reference in its entirety.

What is claimed is:

1. A program recommendation system comprising:
a profile creator which creates a plurality of profiles showing characteristics of programs which a user may like from different aspects; and
a to-be-recommended program determiner which determines at least one program to be recommended to the user, using one of the plurality of profiles.

2. The program recommendation system according to claim 1, further comprising
a recommended-program display unit which displays at least one recommended program determined by said to-be-recommended program determiner.

3. The program recommendation system according to claim 1, wherein:
said profile creator includes
an extraction unit which extracts a plurality of keywords featuring programs which the user may like, from EPG (Electronic Program Guide) data representing information of programs to be broadcasted, and
an adder which adds a predetermined additional value to a profile value representing frequency of extracting each of the plurality of keywords, for each of the plurality of keywords, thereby creating the plurality of profiles;
the plurality of profiles emphasize a plurality of kinds of keywords, respectively; and
said adder changes the additional value for each of the plurality of kinds of keywords, in accordance with a degree of the emphasis.

4. The program recommendation system according to claim 2, wherein:
said profile creator includes
an extraction unit which extracts a plurality of keywords featuring programs which the user may like, from EPG (Electronic Program Guide) data representing information of programs to be broadcasted, and
an adder which adds a predetermined additional value to a profile value representing frequency of extracting each of the plurality of keywords, for each of the plurality of keywords, thereby creating the plurality of profiles;
the plurality of profiles emphasize a plurality of kinds of keywords, respectively and
said adder changes the additional value for each of the plurality of kinds of keywords, in accordance with a degree of the emphasis.

5. The program recommendation system according to claim 3, wherein:
said program recommendation system further includes a record reservation unit which sets a program reserved to be recorded, in accordance with user operations; and
said extraction unit extracts at least one keyword of the program set by said record reservation unit as the keyword featuring the programs that the user may like.

6. The program recommendation system according to claim 4, wherein:
said program recommendation system further includes a record reservation unit which sets a program reserved to be recorded, in accordance with user operations; and
said extraction unit extracts at least one keyword of the program set by said record reservation unit as the keyword featuring the programs that the user may like.

7. The program recommendation system according to claim 5, wherein:
said program recommendation system further includes a program-table display unit which displays a table of programs, based on the EPG data; and
said record reservation unit sets a program that the user selects on the table of programs as the program reserved to be recorded.

8. The program recommendation system according to claim 6, wherein:
said program recommendation system further includes a program-table display unit which displays a table of programs, based on the EPG data; and
said record reservation unit sets a program that the user selects on the table of programs as the program reserved to be recorded.

9. The program recommendation system according to claim 3, wherein:
said program recommendation system further includes a selector making the user select one of the plurality of kinds of keywords; and
said to-be-recommended program determiner determines the at least one program to be recommended, based on the profile which has been created based on the selected kind of keyword.

10. The program recommendation system according to claim 4, wherein:
said program recommendation system further includes a selector making the user select one of the plurality of kinds of keywords; and
said to-be-recommended program determiner determines the at least one program to be recommended, based on the profile which has been created based on the selected kind of keyword.

11. The program recommendation system according to claim 9, wherein
the kinds of keywords include a title, cast, type and contents of a program.

12. The program recommendation system according to claim 10, wherein
the kinds of keywords include a title, cast, type and contents of a program.

13. The program recommendation system according to claim 9, wherein
said recommended-program display unit displays a reason for which the at least one program is determined to be recommended.

14. The program recommendation system according to claim 10, wherein
said recommended-program display unit displays a reason for which the at least one program is determined to be recommended.

15. A program recommendation method, comprising:
creating a plurality of profiles showing characteristics of programs which a user may like from different aspects; and
determining at least one program to be recommended to the user, using one of the plurality of profiles.

16. The program recommendation method according to claim 15, further comprising
displaying the at least one program.

17. The program recommendation method according to claim 15, wherein:
said creating includes
extracting a plurality of keywords featuring programs which the user may like from EPG (Electronic Program Guide) data representing information of programs to be broadcasted, and
adding a predetermined additional value to a profile value representing frequency of extracting each of the plurality of keywords, for each of the plurality of keywords, thereby creating the plurality of profiles;
the plurality of profiles emphasize a plurality of kinds of keywords, respectively; and
said adding includes changing the additional value for each of the plurality of kinds of keywords, in accordance with the a degree of the emphasis.

18. The program recommendation method according to claim 16, wherein:
said creating includes
extracting a plurality of keywords featuring programs which the user may like from EPG (Electronic Program Guide) data representing information or programs to be broadcasted, and
adding a predetermined additional value to a profile value representing frequency of extracting each of the plurality of keywords, for each of the plurality of keywords, thereby creating the plurality of profiles;
the plurality of profiles emphasize a plurality of kinds of keywords, respectively; and
said adding includes changing the additional value for each of the plurality of kinds of keywords, in accordance with the a degree of the emphasis.

19. The program recommendation method according to claim 17, wherein:
said program recommendation method further includes setting a program reserved to be recorded, in accordance with user operations; and
said extracting includes extracting at least one keyword of the program reserved to be recorded, as the keyword featuring the programs that the user may like.

20. The program recommendation method according to claim 18, wherein:
said program recommendation method further includes setting a program reserved to be recorded, in accordance with user operations; and
said extracting includes extracting at least one keyword of the program reserved to be recorded, as the keyword featuring the programs that the user may like.

21. The program recommendation method according to claim 19, wherein:
said program recommendation method further includes displaying a table of programs, based on the EPG data; and
said setting the program reserved to be recorded includes setting a program that the user selects on the table of programs as the program reserved to be recorded.

22. The program recommendation method according to claim 20, wherein:
said program recommendation method further includes displaying a table of programs, based on the EPG data; and
said setting the program reserved to be recorded includes setting a program that the user selects on the table of programs as the program reserved to be recorded.

23. The program recommendation method according to claim 17, wherein:
said program recommendation method further includes making the user select one of the plurality of kinds of keywords; and
said determining includes determining the at least one program to be recommended, based on the profile which has been created based on the selected kind of keyword.

24. The program recommendation method according to claim 18, wherein:
said program recommendation method further includes making the user select one of the plurality of kinds of keywords; and
said determining includes determining the at least one program to be recommended, based on the profile which has been created based on the selected kind of keyword.

25. The program recommendation method according to claim 23, wherein:
the kinds of keywords include a title, cast, type and contents of a program.

26. The program recommendation method according to claim 24, wherein:
the kinds of keywords include a title, cast, type and contents of a program.

27. The program recommendation method according to claim 23, wherein
said displaying the at least one program includes displaying a reason for which each of a plurality of programs is determined to be recommended.

28. The program recommendation method according to claim 24, wherein
said displaying the at least one program includes displaying a reason for which each of a plurality of programs is determined to be recommended.

29. A program for controlling a computer to function as a program recommendation system, comprising:
a profile creator which creates a plurality of profiles showing different aspects of characteristics of programs which users may like; and
a to-be-recommended program determiner which determines at least one program to be recommended to each of the users, using one of the plurality of profiles.
